(19) United States
(12) Patent Application Publication
(10) Pub. No.: US 2026/0258923 A1
(43) Pub. Date: Sep. 3, 2026

(54) LIGHTING DEVICE FOR A MOTOR VEHICLE

(71) Applicant: Hella GmbH & Co. KGaA, Lippstadt (DE)

(72) Inventors: David Duhme, Lippetal (DE); Bernd Fischer, Altenbeken (DE); Piet Risthaus, Dormund (DE)

(21) Appl. No.: 19/654,622

(22) Filed: Apr. 22, 2026

Related U.S. Application Data
(63) Continuation of application No. PCT/EP2023/080771, filed on Nov. 6, 2023.

(51) Int. Cl. F21S 41/147; F21S 41/20; F21S 41/255

(52) U.S. Cl. CPC F21S 41/147; F21S 41/255; F21S 41/285

(57) ABSTRACT

A lighting device for a motor vehicle is provided, and has a plurality of light sources from which light is emitted during operation. Collimating optics are provided through which the light emitted by the light sources at least partially passes. A secondary optics, through which the light emanating from the collimating optics passes at least partially is also provided. The secondary optics have an entrance surface and an exit surface for the light emanating from the collimating optics. The light emanating from the collimation optics, when it strikes the entrance surface of the secondary optics, makes an angle (a) not equal to 0°with the normal to the entrance surface of the secondary optics with respect to a first direction (X) which corresponds to the transverse direction of the motor vehicle.

### CROSS REFERENCE

This application claims priority to PCT Application No. PCT/EP2023/080771, filed Nov. 6, 2023, the entirety of which is hereby incorporated by reference.

### FIELD OF THE INVENTION

The present invention relates to a lighting device for a motor vehicle.

### BACKGROUND OF THE INVENTION

A lighting device of the aforementioned type in the form of a headlamp is known from DE 10 2018 107 213 A1. The lighting device described therein is shown schematically in FIG. 3a. The lighting device comprises three light sources 1, which are only indicated schematically and are designed as light-emitting diodes (LEDs). Light 2 is emitted from the light sources 1 during operation of the lighting device. The lighting device further comprises collimating optics 3 with three collimating lenses 4 arranged next to one another in the transverse direction of the vehicle, one of the collimating lenses 4 being assigned in each case to one of the light sources 1, so that the light emanating from one of the light sources 1 passes through the assigned collimating lens 4. The lighting device further comprises a secondary optics 5 through which the light 2 emanating from the collimating optics 3 passes. In this regard, the secondary optics 5 has an array of cylindrical lenses 6 arranged on an entrance surface of the secondary optics 5 facing the collimating optics 3. The cylindrical lenses 6 have vertically aligned cylindrical axes, so that the array of cylindrical lenses 6 causes a horizontal spread of the light distribution.

A disadvantage of this prior art lighting device is that the exit surface 7 of the secondary optics, which is visible to the observer from the outside, is inhomogeneously illuminated. FIG. 3b shows that non-illuminated areas 9 are arranged between the individual illuminated areas 8.

### BRIEF SUMMARY OF THE INVENTION

The object of the present invention is to provide a lighting device of the type mentioned above, which has a more homogeneously illuminated light exit surface.

In an example embodiment, it is provided that the lighting device is arranged so that the light emanating from the collimation optics, when it strikes the entrance surface of the secondary optics, encloses an angle not equal to 0° with the normal to the entrance surface of the secondary optics with respect to a first direction which, in the state of the lighting device installed in the motor vehicle, corresponds to the transverse direction of the motor vehicle. For example, the angle with respect to the first direction between the light incident on the entrance surface and the normal on the entrance surface may be between 10° and 80°, in particular between 20° and 70°. This oblique illumination of the entrance surface of the secondary optics results in a more homogeneously illuminated light exit surface.

It can be provided that the collimation optics has an optical axis and is arranged in the lighting device in such a way that the optical axis of the collimation optics encloses an angle other than 0° with respect to the first direction with the normal on the entrance surface of the secondary optics. For example, the angle with respect to the first direction between the optical axis of the collimation optics and the normal on the entrance surface of the secondary optics can be between 10° and 80°, in particular between 20° and 70°.

It is possible for the secondary optics to comprise an array of prisms arranged in particular on the entrance surface of the secondary optics. In this case, the array of prisms can be arranged to deflect the light incident on the entrance surface, in particular to deflect it so that it emerges from the exit surface parallel to the normal to the exit surface. This ensures that the light incident obliquely on the secondary optics nevertheless emerges from the lighting device in the longitudinal direction of the vehicle.

It may be provided that the array of prisms is part of a microprism foil, which is preferably arranged on the entrance surface. Alternatively, the secondary optics can be disk-shaped, whereby the array of prisms is formed on the disk-shaped secondary optics, in particular on the entrance surface of the secondary optics.

It is possible that the center-to-center distance between adjacent prisms of the array of prisms is between 0.1 mm and 1.0 mm. By such small dimensions of the prisms, it can be achieved that for an observer the structuring by the prisms is not visible.

It may be provided that the secondary optics comprises an array of cylindrical lenses through which, during operation of the lighting device, the light emanating from the collimating optics passes at least partially. In this context, it may be provided that the cylindrical lenses are arranged side by side in the first direction and that the cylindrical axes of the cylindrical lenses extend in a second direction which corresponds to the vertical when the lighting device is installed in the motor vehicle. Due to the vertical alignment of the cylindrical axes, the light distribution generated by the lighting device is spread horizontally.

It is possible that the cylindrical lenses are arranged on the entrance surface and/or on the exit surface of the secondary optics. In particular, an arrangement on the entrance surface increases the horizontal spread of the light passing through the secondary optics.

It may be provided that the cylindrical lenses are integrated into the array of prisms. This results in a compact and effective design of the secondary optics.

It is possible for the collimation optics to comprise a plurality of collimation lenses. In this context, it may be provided that in each case, one of said collimating lenses is associated with one of said light sources in such a manner that light emanating from said light source passes through said associated collimating lens. By selecting a plurality of light sources and collimating lenses arranged side by side in the horizontal direction, the strength and width of the light distribution can be increased.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1a illustrates a top view of a first embodiment of a lighting device according to an example embodiment of the invention.

FIG. 1b illustrates a front view of the lighting device shown in FIG. 1a.

FIG. 2a illustrates a top view of a second embodiment of a lighting device according to an example embodiment of the invention.

FIG. 2b illustrates a front view of the lighting device according to FIG. 2a.

FIG. 3a illustrates a top view of an embodiment of a prior art lighting device.

FIG. 3b illustrates a front view of the lighting device according to FIG. 3a.

### DETAILED DESCRIPTION OF THE DRAWINGS

In the figures, identical and functionally identical parts are given the same reference signs.

A Cartesian coordinate system is drawn in some of the figures for better orientation. Here, a first direction X corresponds to the transverse direction of the vehicle when the lighting device is installed in the vehicle. Thus, the first direction X extends horizontally when the lighting device is installed in the vehicle. A second direction Y corresponds to the vertical direction when the lighting device is installed in the vehicle. A third direction Z perpendicular to the first and second directions X, Y corresponds to the longitudinal direction of the vehicle. The third direction Z thus also extends horizontally when the lighting device is installed in the vehicle.

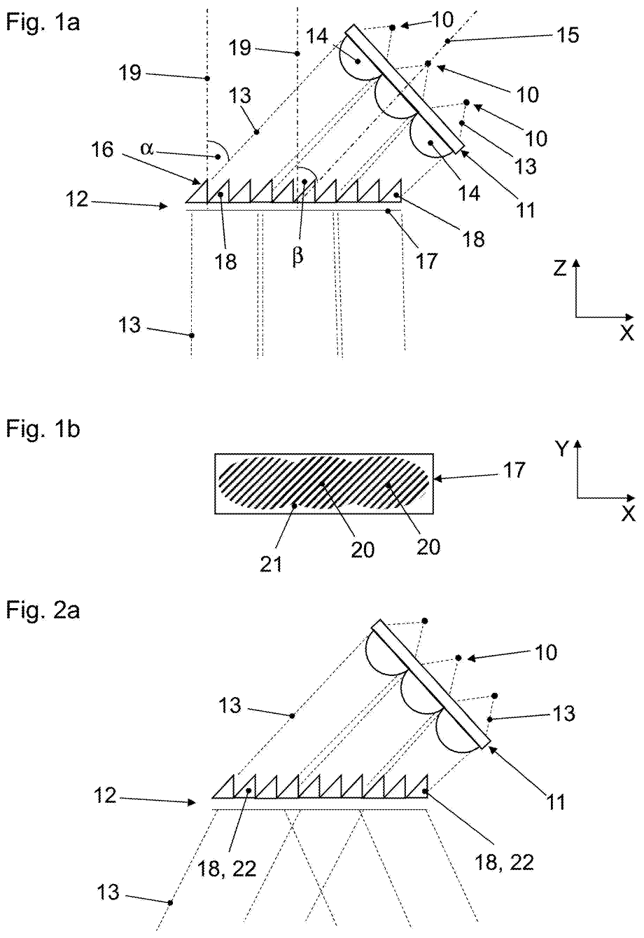

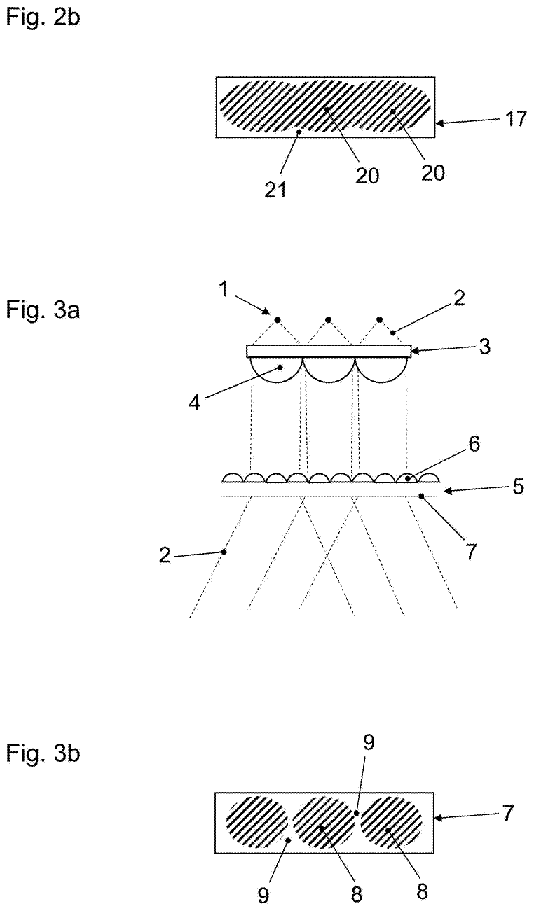

The lighting device shown in FIGS. 1a to 2b is designed as a headlamp. The lighting device comprises three light sources 10, which are only schematically indicated, a collimation optics 11 and a secondary optics 12 (see FIG. 1a and FIG. 2a). The light sources 10 are designed as light-emitting diodes (LEDs) from which light 13 is emitted during operation of the lighting device. In this case, the light sources 10 are arranged next to each other and spaced apart from each other in the first direction X.

It is quite possible to provide more or less than three light sources 10.

The embodiment of the collimating optics 11 illustrated in the figures is formed as a single piece and is adapted to allow light emanating from the light sources 10 to pass through the collimating optics at least partially 11 during operation of the lighting device. In the illustrated embodiment, the collimating optics 11 comprises a row of three collimating lenses 14 arranged side by side.

It is quite possible to provide more than three or less than three collimating lenses 14. Furthermore, it is quite possible not to connect the collimating lenses 14 of the collimating optics 11 in one piece, but to form them on separate substrates.

The collimating lenses 14 each have an entrance surface facing the light sources 10 and an exit surface opposite the entrance surface. A collimating lens 14 is assigned to each of the light sources 10 and is arranged in front of the light source 10 in such a way that the light emitted by the light sources 10 is largely collimated by the respectively assigned collimating lens 14.

The collimation optics 11 or the individual collimation lenses 14 have an optical axis 15, which is indicated by a dashed line in FIG. 1a. The optical axis 15 of the collimation optics 11 is inclined relative to the third direction Z or the longitudinal direction of the vehicle when the lighting device is installed in the motor vehicle.

In the illustrated embodiments, the secondary optics 12 consists of only one substantially disk-shaped optical component or comprises only one substantially disk-shaped optical component in the illustrated embodiments. Alternatively, it may be provided that the secondary optics 12 comprises more than one optical component. The secondary optics 12 has an entrance surface 16 facing the collimating optics 11 and an exit surface 17 opposite thereto.

The secondary optics 12 of the first embodiment illustrated in FIG. 1a and FIG. 1b has an array of prisms 18 on the entrance surface 16, which are arranged side by side in the first direction X. In the state of the lighting device installed in the motor vehicle, the secondary optics 12 is arranged in the lighting device in such a way that the normal 19 on the entrance surface 16 is parallel to the third direction Z or the longitudinal direction of the vehicle.

The so-called pitch or the center-to-center distance between prisms 18 adjacent in the first direction X of the array of prisms 18 may be between 0.1 mm and 1.0 mm.

The array of prisms 18 may be part of a microprism foil that is applied, in particular glued, to the entrance surface 16. Alternatively, the array of prisms 18 may be formed in the entrance surface 16 of the secondary optics 12.

The largely collimated light 13 emanating from the collimation optics 11 impinges on the entrance surface 16 with respect to the first direction X at an angle α to the normal 19 on the entrance surface 16 which is not equal to 0°. The angle α can preferably be between 10° and 80°, in particular between 20° and 70°. In the illustrated embodiment examples, for example, the angle α is approximately 45°.

If the light 13 is not collimated, the average propagation direction of the light 13 emanating from the collimating optics 11 and impinging on the entrance surface 16 encloses the angle α with respect to the first direction X with the normal 19 on the entrance surface 16.

With respect to the first direction X, the optical axis 15 of the collimation optics 11 encloses an angle β not equal to 0° with the normal 19 on the entrance surface 16 of the secondary optics 12. The angle β can preferably be between 10° and 80°, in particular between 20° and 70°. In the illustrated embodiment examples, for example, the angle β is approximately 45°.

In the illustrated embodiments, the two angles a and b are equal. However, it is quite possible that the light 13 emitted by the collimating optics 11 is not parallel to the optical axis 15 of the collimating optics 11. In this case, the two angles a and b may be unequal.

The prisms 18 on the entrance surface 16 of the secondary optics 12 deflect the light 3 in such a way that, after passing through the secondary optics 12, it propagates essentially in the negative Z direction or in the longitudinal direction of the vehicle.

FIG. 1b illustrates that the oblique incidence of light 13 illuminates the exit surface 17 of the secondary optics 12 comparatively homogeneously. Due to the oblique incidence of light, the light components emitted by the individual light sources 10 and the collimating lenses 14 assigned to them are broadened in the first direction X, so that the illuminated areas 20 resulting from this overlap each other and the non-illuminated areas 21 become very small.

The secondary optics 12 of the second embodiment illustrated in FIG. 2a and FIG. 2b has, in addition to the array of prisms 18, an array of cylindrical lenses 22 which are also arranged side by side in the first direction X. The cylindrical axes of these cylindrical lenses 22 extend in the second direction Y or, in the installed state of the lighting device, in the vertical direction.

The array of cylindrical lenses 22 is integrated into the array of prisms 18 in the illustrated embodiments. However, it is quite possible that the array of cylindrical lenses 22 is separated from the array of prisms 18 and is arranged, for example, on the exit surface 17 of the secondary optics 12.

As in the first embodiment, the light 13 in the second embodiment is deflected in such a way that, after passing through the secondary optics 12, it propagates essentially in the negative Z direction or in the longitudinal direction of the vehicle. Due to the array of cylindrical lenses 22, the light 13 passing through the secondary optics 12 is additionally broadened in the first direction X or in the transverse direction of the vehicle (see FIG. 2a).

### LIST OF REFERENCE SIGNS

1 Light source
2 Light emitted from the light source
3 Collimation optics
4 Collimating lens
5 Secondary optics
6 Cylindrical lens
7 Exit surface of the secondary optics
8 Illuminated area of the exit surface of the secondary optics
9 Non-illuminated area of the exit surface of the secondary optics
10 Light source
11 Collimation optics
12 Secondary optics
13 Light emitted from the light source
14 Collimating lens of collimating optics
15 Optical axis of the collimation optics
16 Entrance surface of the secondary optics
17 Exit surface of the secondary optics
18 Prism of the array of prisms of the secondary optics
19 Normal on the entrance surface of the secondary optics
20 Illuminated area of the exit surface of the secondary optics
21 Non-illuminated area of the exit surface of the secondary optics
22 Cylindrical lens of the array of cylindrical lenses of the secondary optics
X First direction
Y Second direction
Z Third direction
α Angle between the incident light and the normal on the entrance surface of the secondary optics
β Angle between the optical axis of the collimating optics and the normal on the entrance surface of the secondary optics

1. A lighting device for a motor vehicle, the lighting device comprising:
a plurality of light sources from which light is emitted during operation of the lighting device;
collimating optics through which the light emitted by the light sources at least partially passes;
a secondary optics through which the light emanating from the collimating optics passes at least partially, the secondary optics having an entrance surface and an exit surface for the light emanating from the collimating optics;
wherein the light emanating from the collimation optics, upon striking the entrance surface of the secondary optics, encloses an angle (α) not equal to 0° with a normal to the entrance surface of the secondary optics with respect to a first direction (X) which corresponds to the transverse direction of the motor vehicle.

2. The lighting device according to claim 1, wherein the angle (α) with respect to the first direction (X) between the light incident on the entrance surface and the normal on the entrance surface is between 10° and 80°.

3. The lighting device according to claim 1, wherein the collimating optics has an optical axis, wherein the optical axis of the collimating optics encloses an angle (β) not equal to 0° with respect to the first direction (X) with the normal on the entrance surface of the secondary optics.

4. The lighting device according to claim 3, wherein the angle (β) with respect to the first direction (X) between the optical axis of the collimating optics and the normal on the entrance surface of the secondary optics is between 10° and 80°.

5. The lighting device according to claim 1, wherein the secondary optics comprises an array of prisms.

6. The lighting device according to claim 5, wherein the array of prisms is arranged to deflect the light incident on the entrance surface.

7. The lighting device according to claim 5, wherein the array of prisms is part of a microprism sheet.

8. The lighting device according to claim 5, wherein the secondary optics is disc-shaped, wherein the array of prisms is formed on the disc-shaped secondary optics.

9. The lighting device of according to claim 5, wherein center-to-center spacing between adjacent prisms of the array of prisms is between 0.1 mm and 1.0 mm.

10. The lighting device according to claim 1, wherein the secondary optics comprises an array of cylindrical lenses through which the light emitted by the collimating optics passes at least partially.

11. The lighting device according to claim 10, wherein the cylindrical lenses are arranged side by side in the first direction (X), and wherein cylindrical axes of the cylindrical lenses extend in a second direction (Y) which corresponds to a vertical when the lighting device is installed in the motor vehicle.

12. The lighting device according to claim 10, wherein the cylindrical lenses are arranged on the entrance surface and/or on the exit surface of the secondary optics.

13. The lighting device according to claim 10, wherein the secondary optics comprises an array of prisms, and wherein the cylindrical lenses are integrated into the array of prisms.

14. The lighting device according to claim 1, wherein the collimating optics comprises a plurality of collimating lenses.

15. The lighting device according to claim 14, wherein each one of said collimating lenses is associated with a respective one of said light sources such that light emanating from each said light source passes through its associated collimating lens.

16. The lighting device according to claim 5, wherein the array of prisms is arranged on the entrance surface of the secondary optics.

17. The lighting device according to claim 6, wherein the array of prisms is arranged to deflect the light incident on the entrance surface so that it emerges from the exit surface parallel to the normal to the exit surface.

18. The lighting device according to claim 7, wherein the array of prisms is arranged on the entrance surface.

19. The lighting device according to claim 8, wherein the secondary optics is formed on the entrance surface of the secondary optics.
